(19) United States
(12) Patent Application Publication
(10) Pub. No.: US 2014/0301328 A1
(43) Pub. Date: Oct. 9, 2014

(54) Wireless Access Point Alternate Settings

(71) Applicant: Bob Daniel Yacovitch, St. Laurent (CA)

(72) Inventor: Bob Daniel Yacovitch, St. Laurent (CA)

(21) Appl. No.: 14/347,282

(22) PCT Filed: Dec. 20, 2011
(86) PCT No.: PCT/US2011/066080

§ 371 Date: Mar. 26, 2014

(51) Int. Cl. H04W 74/00

(52) U.S. Cl. CPC H04W 74/002
USPC 370/329

(57) ABSTRACT

Embodiments disclosed herein relate to wireless access point alternate settings. For example, a processor may select a primary and alternate radio channel for a wireless access point. In one embodiment, the alternate channel is a non-radar designated channel. In one embodiment, the primary and alternate radio channels are selected based on a network topology map. In one embodiment, a processor uses a network topology map to select wireless access point alternate settings to be transmitted where failure of a wireless access point failure is detected.

### BACKGROUND

Wireless networks allow client devices to have more flexibility as to their locations while still communicating on a network. Wireless access points may connect to a network via a wired connection and communicate wirelessly with client devices to provide network access to the client devices. The wireless access points may transmit information to the client devices on a radio channel and at a power level determined by a central controller that manages network parameters.

### BRIEF DESCRIPTION OF THE DRAWINGS

The drawings describe example embodiments. The following detailed description references the drawings, wherein:

FIG. 1 is a block diagram illustrating one example of a computing system,

FIG. 2 is a flow chart illustrating one example of a method to create a wireless access point radio channel communication alternate plan.

FIG. 3A is a diagram illustrating one example of a wireless access point radio channel communication plan.

FIG. 3B is a flow chart illustrating one example of a wireless access point communicating on a primary and alternate channel.

FIG. 4 is a block diagram illustrating one example of a computing system.

FIG. 5 is a flow chart illustrating one example of a method to create a wireless access point radio channel communication alternate plan.

FIG. 6A is a diagram illustrating one example of a network topology map.

FIG. 6B is a diagram illustrating one example of a wireless access radio channel communication plan.

FIG. 7 is a Nock diagram illustrating one example of a computing system.

FIG. 8 is a flow chart illustrating one example of a method to create a wireless access point coverage alternate plan.

FIG. 9A is a diagram illustrating one example of a network t polo map.

FIG. 9B is a diagram illustrating one example of wireless access point failure plan.

### DETAILED DESCRIPTION

A wireless network may create alternate plans for reacting to common issues, such as network interference and wireless access point failure. The mitigation information may be determined and stored such that it may be retrieved for use if an issue arises. Having a mitigation plan available may prevent extensive real-time analysis at the time of the issue, resulting in a shorter time period before the problem is addressed.

As an example, a primary and alternate communication channel may be selected for each wireless access point and stored such that the alternate channel may be already determined in the event that the primary communication channel is no longer available or desirable. The primary channels for wireless access points may be set to radar designated channels, and the alternate channels for wireless access points may be set to non-radar designated channels. To comply with radio regulations on the 5 GHz band that prevent a channel from being used when radar is detected, a wireless access point may scan for radar at regular intervals and scan for radar for a particular time period when first starting to communicate on a radar designated channel. If an access point switches to communicating on another channel due to radar detection or other types of radio interference, the access point may be unable to communicate during the time it is performing the initial scan for radar. Due to the limited number of non-radar designated channels, it may not be possible for each wireless access point to communicate on a non-radar designated channel without increasing the likelihood of co-channel interference. The non-radar designated channels may be used as alternate channels due to the low likelihood that each wireless access point would be simultaneously communicating using its associated alternate channel.

As another example of a wireless access point alternate plan, an alternate communication channel may be selected using a network topology may in a manner that reduces the likelihood of co-channel interference. For example, the 2.4 GHz band for communication in North America may be limited to three non-overlapping channels, which may increase the likelihood of co-channel interference occurring where nearby wireless access points communicate using the same channel. A network topology nearest neighbor map may be used to determine how to allocate the channels as primary and alternate channels for the wireless access points in a manner that reduces the likelihood of co-channel interference.

As another example of a wireless access point alternate plan, a mitigation plan may be created to address failure of a wireless access point. A wireless network controller may use a network topology map to determine changes that other access points may make in response to a wireless access points failing. For example, the other access points may transmit using a different channel with a larger range or transmit at a higher power so that silent devices previously connected to the failed wireless access point may connect to one of the other wireless access points.

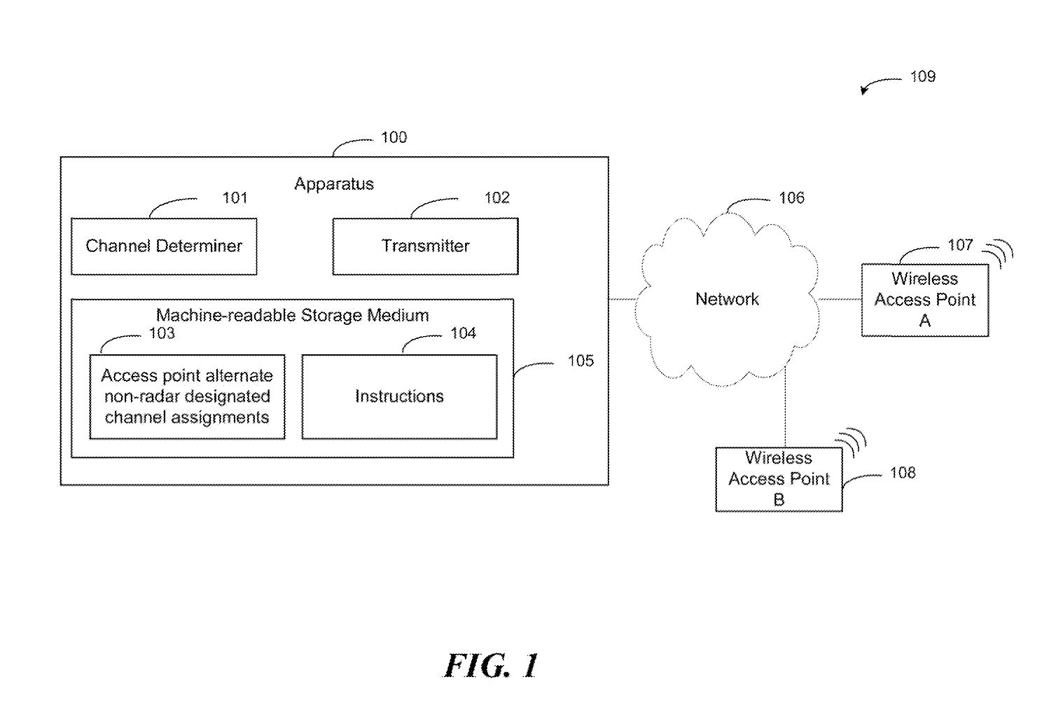

FIG. 1 is a block diagram illustrating one example of a computing system 109. The computing system 109 includes an apparatus 100, a network 106, a wireless access point A 107, and a wireless access point B 108. The computing system 109 may set a primary radar designated communication channel and an alternate non-radar designated communication channel for the wireless access points A 107 and B 108 to use to wirelessly communicate with client devices (not shown).

The wireless access point A 107 and the wireless access point B 108 may be any suitable wireless access points. The wireless access points A 107 and B 108 may be used to provide network access to client devices, such as by transmitting information wirelessly via radio frequencies to client devices. In some implementations, the wireless access points A 107 and B 108 may be combined with other network hardware, such as a router.

The network 106 may be, for example, the Internet or a Local Area Network (LAN). The network 106 may be used to communicate settings information from the apparatus 100 to the wireless access points A 106 and B 107. For example, the apparatus may send information about communication channels or power levels to the wireless access points A 107 and B 108. The network 108 may be a wired network for transmitting information to the wireless access points A 107 and B 108, and the wireless access points A 107 and B 108 may wirelessly transmit data to client devices using radio frequencies. For example, client devices within a particular radius of wireless access point A 107 may communicate with the wireless access point A 107 to receive network access.

The apparatus 100 may be any suitable apparatus for controlling network parameters. For example, the apparatus 100 may be a network controller, such as a wireless Local Area Network (LAN) controller, for centrally managing radio frequency power, channel, authentication, and security of wireless access points. The apparatus 100 may include a channel determiner 101, a transmitter 102, and a machine-readable storage medium 105. The transmitter 102 may transmit information from the apparatus 100 to wireless access points, such as wireless access point A 107 and B 108, via the network 106.

The machine-readable storage medium 105 may be any suitable machine readable medium, such as an electronic, magnetic, optical, or other physical storage device that stores executable instructions or other data (e.g., a hard disk drive, random access memory, flash memory, etc.). The machine-readable storage medium 105 may be, for example, a computer readable non-transitory medium. The machine-readable storage medium 105 may include alternate non-radar designated assignments 103 and instructions 104 executable by the channel determiner 101. In some implementations, the alternate non-radar designed assignments 103 are stored in a separate storage than the instructions 104. In some implementations, the channel determiner 101 is implemented in hardware and does not execute instructions 104

The channel determiner 101 may be, for example, a processor, such as a central processing unit (CPU), a semiconductor-based microprocessor, or any other device suitable for retrieval and execution of instructions 104. In one embodiment, the channel determiner 101 includes logic instead of or in addition to a processor. As an alternative or in addition to fetching, decoding, and executing instructions 104, the channel determiner 101 may include one or more integrated circuits (ICs) or other electronic circuits that comprise a plurality of electronic components for performing the functionality described below. In one implementation, the channel determiner 101 includes multiple processors. For example, one processor may perform some functionality and another processor may perform other functionality.

The channel determiner 101 may select an alternate channel for a wireless access point from a group of non-radar designated channels. The determined access point alternate non-radar designated assignment 103 may be stored in the machine-readable storage medium 105 where the transmitter 102 may access it to transmit it to the wireless access point. For example, the transmitter 102 may transmit the information about the alternate channel to the wireless access point via the network 106 to allow the wireless access point to begin communicating on the alternate channel. Using a non-radar designated channel as an alternate channel may allow a wireless access point to begin transmitting on the alternate channel without first waiting to see if radar is detected in order to comply with regulations. In some cases, a channel determiner, either the same component as the channel determiner 101 or a different component, may assign a radar designated channel to a wireless access point as a primary channel such that the wireless access point communicates on the primary channel until radar detection or another interference issue is detected on the primary channel.

As an example, a first wireless access point, such as wireless access point A 107, and a second access point, such as wireless access point B 108, may each operate using different radio channels, and each of the wireless access points may have the same alternate radio channel. For example, in the event that radar is detected or another interference issue occurs in the primary channel used by wireless access point A 107, the channel determiner 101 may retrieve information about the associated alternate channel from the machine-readable storage medium 105 and transmit information about the alternate channel to the wireless access point A 107. The wireless access point A 107 may then begin communicating using the alternate channel without being delayed by scanning for radar to comply with regulations regarding radar designated channels.

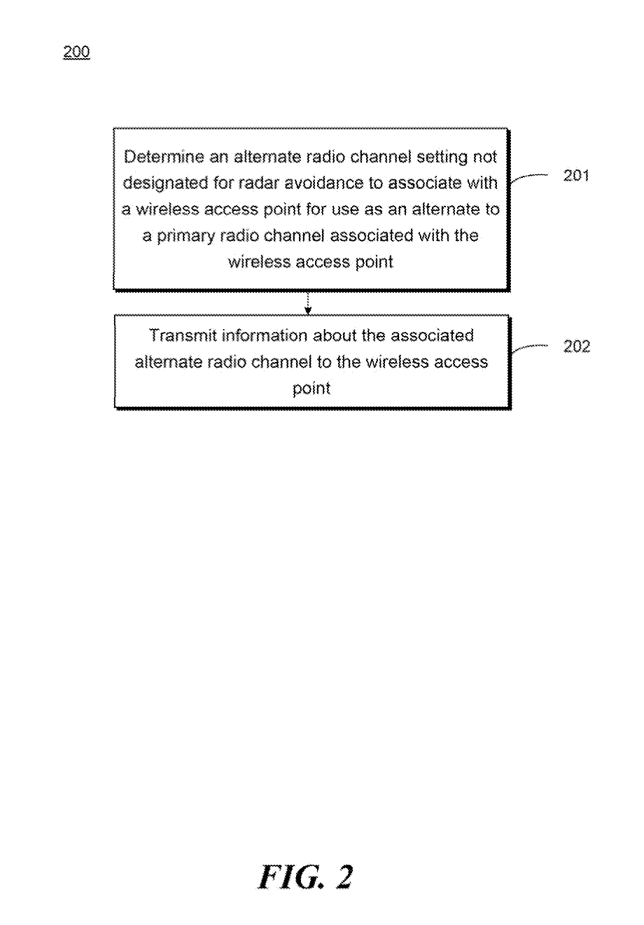

FIG. 2 is a flow chart 200 illustrating one example of a method to create a radio channel communication alternate plan. A communication channel alternate may be selected for each of the wireless access points in a network, or for each of a group of wireless access points in a network. Information about the alternate channels may be stored such that in the event that an access point's primary communication channel experiences interferences or no longer provides sufficient resources the access point switches to using the predetermined alternate channel. In the 5 GHz band, regulations mandate that an access point using a dynamic frequency selection channel monitor for radar periodically and when initially using certain radio channels. The primary communication channel for each of the wireless access points may be selected from the group of radar designated channels, and the alternate channel may be selected from the group of non-radar designated channel. The method may be implemented by a central network controller. For example, the method may be implemented by the apparatus 100 from FIG. 1.

Beginning at 201, a channel determiner, such as the channel determiner 101, determines an alternate radio channel setting not designated for radar avoidance to associate with a wireless access point for use as an alternate to the primary radio channel associated with the wireless access point. The processor may select the alternate radio channels in any suitable manner. As an example, the channel determiner 101 of FIG. 1 may assign the wireless access points A 107 and B 108 the same alternate non-radar designated channel or different alternate non-radar designated channels. The likelihood of co-channel interference where the same alternate channel is chosen may be reduced because of the lower likelihood that both wireless access points A 107 and B 108 would switch to communicating on their alternate channels.

The process of determining an alternate channel may occur at any suitable time, such as initially when the wireless access point begins communicating or while the wireless access point is communicating on the primary channel. In some cases, the alternate channels may be periodically updated. If a wireless access point switches to communicating on its alternate channel, other access points, such as nearby access points, may have their alternate channels changed. For example, alternates may be reassigned such that co-channel interference does not occur if a large number of access points communicate using their alternate channels. Once a wireless access point begins using its alternate channel, the processor may determine whether the alternate channel of other wireless access points should be updated. In some cases, updated primary or alternate channels may be determined at an idle time.

Proceeding to 203, a transmitter, such as the transmitter 102, transmits information about the associated alternate radio channel to the wireless access point. For example, an access point may stop communicating using its assigned primary channel because of radar detection on a radar designated primary channel or due to non-802.11 interference type issues. In such a case, the processor may transmit via a network information about that access point's predetermined alternate channel to the access point. The access point may then begin communicating using the alternate channel. The access point may begin communicating on the alternate channel without first delaying by scanning for radar where the alternate channel is a non-radar designated channel. In some cases, the processor may send information about the alternate channel to the wireless access point, and the wireless access point stores information about the alternate channel for later use when the primary channel is no longer used.

In one implementation, a channel determiner determines a primary radio channel designated for radar avoidance to associate with a wireless access point. The channel determiner may select communication channels for an entire network of wireless access points or a subset of the wireless access points. The number of non-radar designated channels may be limited to the point that using non-radar designated channels for each of the primary radio channels may result in co-channel interference and poor performance due to the number of wireless access points sharing each of the limited number of channels. The radar designated channels may be numerous enough that they may serve as primary communication channels without causing co-channel interference and performance issues. The processor may select the primary radio channel in any suitable manner. For example, the processor may consider the number of other access points communicating on the same channel and other factors.

A transmitter may transmit information about the associated primary radio channel to the wireless access point. For example, the transmitter may transmit the information via a wired network. The processor may transmit the information when it is determined or at a later time. The wireless access points may each transmit information on their assigned primary radio frequency channels. Client devices may then communicate with the wireless access points on the associated primary channels.

As an example, the channel determiner 101 from FIG. 1 may associate a first dynamic frequency selection channel with wireless access point A 107 and a second dynamic frequency channel with wireless access point B 108. The wireless access points A 107 and B 108 may wireless transmit information to client devices using the assigned primary communication channels until interference or another issue is experienced. While communicating on the primary channel that is radar designated, the wireless access points A 107 and B 108 may comply with regulations related to radar, such as by periodically monitoring for the detection of radar on the channel.

The processor may update the primary communication channels. For example, the processor may periodically analyze the communication channels in use to determine whether to make changes. If a first wireless access point switches from its primary channel to its alternate channel due to radar detection or other interference, the process may switch other access points using the same primary channel to a different communication channel to prevent the same issue from arising. In some cases, access points nearby the first access point may switch to a different communication channel. For example, if radar is detected in a communication channel, it may be detected by access points nearby the access point detecting radar. To prevent a change being made later in response to the radar, a new primary communication channel may be determined for wireless access points within a particular proximity of the wireless access point, and information about the new channel may be sent to the wireless access points.

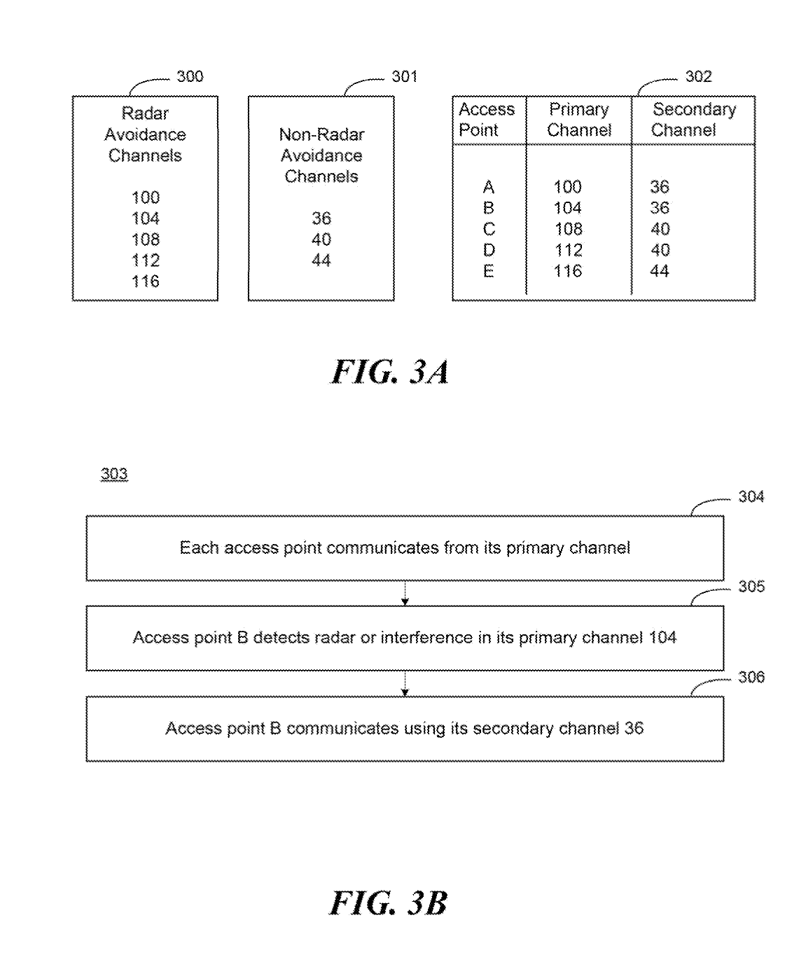

FIG. 3A is a diagram illustrating one example of a wireless access radio channel communication plan. Block 300 shows a set of radar avoidance channels including radio channels 100, 104, 108, 112, and 116, and block 301 shows non-radar avoidance channels 36, 40, and 44. Block 302 shows the primary and alternate channels selected for wireless access points A. B, C, D, and E. For example, wireless access point A communicates using radio channel 100 and has non-radar avoidance channel 36 assigned as an alternate.

FIG. 3B is a flow chart 303 illustrating one example of a wireless access point communicating on a primary and alternate channel. At 304, each of the access points A, B, C, D, and E communicate from their primary channels. For example, the wireless access points may receive information from a central controller indicating which radio channel they should use. At 305, wireless access point B detects radar or other interference in its primary channel 104. At 306, access point B receives information from the central controller indicating that wireless access point B should begin using channel 36 to communicate, and access point B begins to communicate using channel 36. Channel 36 is one of the non-radar designated channels, and access B begins to communicate using channel 36 without first delaying by scanning for radar. Additionally, the time period for sending wireless access point B its alternate channel may be shorter because the alternate channel is predetermined and stored.

In some cases, a test may be performed to determine the effectiveness of communication on the primary and alternate channels. For example, a condition to disrupt the communication of a wireless access point on its primary radio channel may be simulated. A central controller may then monitor the communications of the wireless access point to determine whether it properly switches to communicate on its alternate channel and to determine whether client devices are able to communicate with the wireless access point on its alternate channel. The effect on other wireless access points may also be monitored. For example, it may be determined whether the communication on the alternate channel causes co-channel interference. Results from the monitoring may be output, such as displayed, transmitted, or stored. A network administrator may receive the results to determine whether the network may be able to adequately respond when a primary radio channel is no longer used

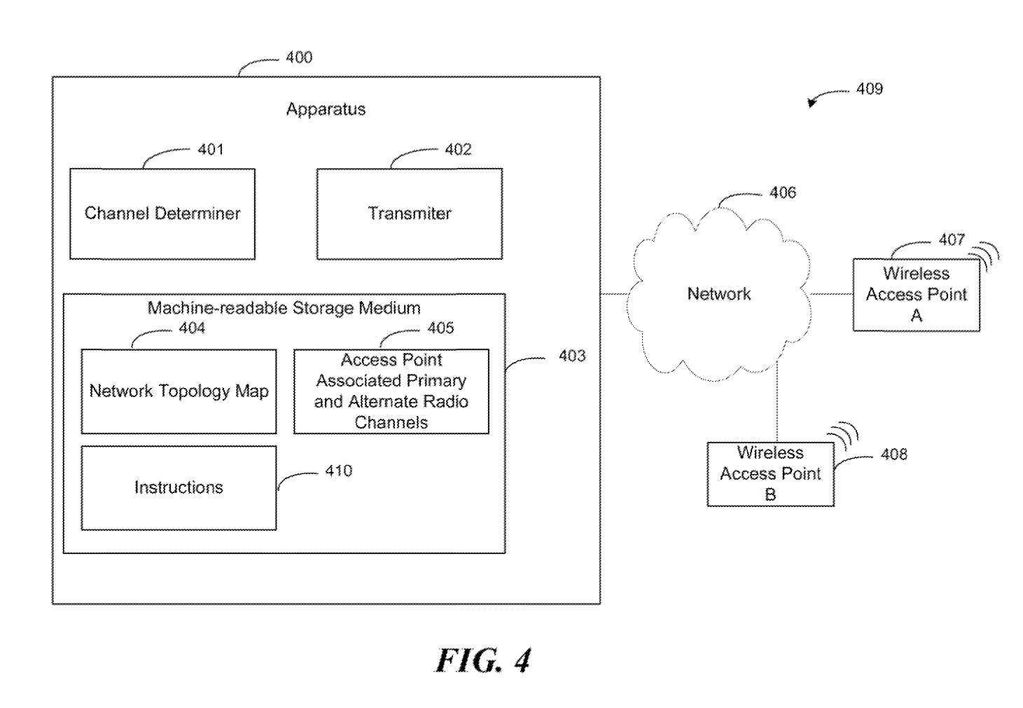

FIG. 4 is a block diagram illustrating one example of a computing system 409. The computing system 409 includes an apparatus 400, a network 406, a wireless access point A 407, and a wireless access point B 408. The computing system 409 may determine a primary and alternate communication channel for the wireless access points A 407 and B 408 used on a network topology map of wireless access points. Using the network topology indicating the relative location of access points may lessen the likelihood of co-channel interference. For example, an alternate radio frequency channel may be selected such that nearby access points do not share the same channel as a primary or alternate channel.

The wireless access points A 407 and B 408 may provide network access to client devices (not shown), For example, the wireless access points A 407 and B 408 may transmit information wirelessly via radio frequencies to client devices. In some implementations, the wireless access points A 407 and B 408 may be combined with other network hardware, such as a router.

The network 406 may be any suitable network, such as the Internet or a Local Area Network. The network 406 may be used to communicate information from the apparatus 400 to the wireless access points A 407 and B 408. For example, the apparatus may send information about communication channels or power level to the wireless access points A 407 and B 408. The network 406 may be a wired network for transmitting information to the wireless access points A 407 and B 408, and the wireless access points A 407 and B 408 may wirelessly transmit data to client devices using radio frequencies.

The apparatus 400 may be any suitable apparatus for determining wireless access point settings. For example, the apparatus 400 may be a network controller, such as a wireless Local Area Network (LAN) controller, for centrally managing radio frequency power, channel, authentication, and security of wireless access points, The apparatus 400 may include a channel determiner 401, a machine-readable storage medium 403, and a transmitter 402.

The channel determiner 401 may be a processor, such as a central processing unit (CPU), a semiconductor-based microprocessor, or any other device suitable for retrieval and execution of instructions. In one embodiment, the channel determiner 401 includes logic instead of or in addition to a processor. As an alternative or in addition to fetching, decoding, and executing instructions, the channel determiner 401 may include one or more integrated circuits (ICs) or other electronic circuits that comprise a plurality of electronic components for performing the functionality described below. In one implementation, the channel determiner 401 includes multiple processors. For example, one processor may perform some functionality and another processor may perform other functionality.

The transmitter 402 may be a hardware component for transmitting information via the network 408. For example, the transmitter 402 may transmit channel information to the wireless access points A 407 and B 408 that is determined by the channel determiner 401. The transmitter 402 may transmit the channel information, for example, over a wired network.

The machine-readable storage medium 403 may be any suitable machine readable medium, such as an electronic, magnetic, optical, or other physical storage device that stores executable instructions or other data (e.g., a hard disk drive, random access memory, flash memory, etc.). The machine-readable storage medium 403 may be, for example, a computer readable non-transitory medium. The machine-readable storage medium 403 may include instructions 410, network topology map 404, and access point associated primary and alternate channels 405. The instructions 410 may include instructions executable by the channel determiner 401 to determine access point associated primary and alternate channels 405 based on the network topology map 404. In some cases, the instructions 410, network topology map 404, and access point associated primary and alternate channels 406 may be stored in separate storages.

The network topology map 404 may be a nearest neighbor map indicating the relative position of access points within the network. The network topology map 404 may be used to determine primary and alternate communication channels unlikely to result in co channel interference. Two wireless access points close to one another may experience co-channel interference where they both communicate using the same channel, For example, co-channel interference may occur in the 2.4 GHz band where there are three non-overlapping radio channels for transmission in North America. The limited number of channels may make it more likely that wireless access points use the same radio charmed to communicate. Having a predetermined alternate communication channel for each wireless access point may allow for the alternate channels to be selected to prevent co-channel interference without consuming a large amount of time at the time when a wireless access point experiences interference causing it to switch to the alternate channel.

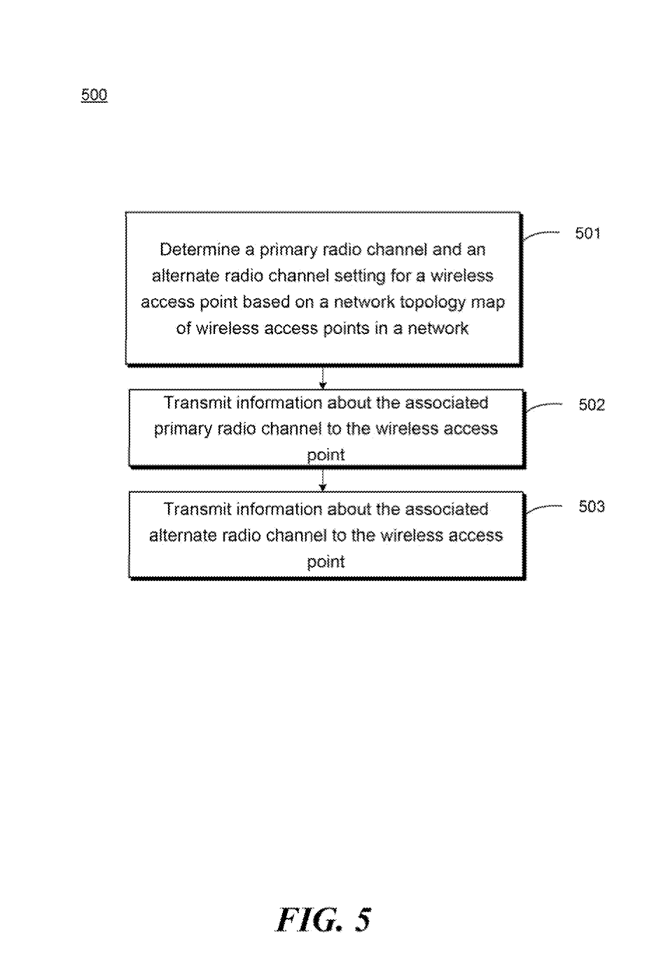

FIG. 5 is a flow chart 500 illustrating one example of a method to create a radio channel communication alternate plan. Predetermining an alternate channel may allow the switch from a primary channel to an alternate channel to occur more quickly where the analysis is done in advance. The primary and alternate channels may be selected using a network topology map to lessen the amount of co-channel interference. The selection may occur at a time of less network traffic. The method may be implemented by a central network controller, for example, by the apparatus 400 from FIG. 4.

Beginning at 501, a channel determiner, such as the channel determiner 401 from FIG. 4, determines a primary radio channel and an alternate radio channel setting a wireless access point based on a network topology map of the wireless access points in a network. The primary channel may be selected in any suitable manner. The primary channel may be selected in a manner designed to prevent co-channel interference. The alternate channel may in some cases be selected such that if it is used it is unlikely to interfere with the primary channels of the other wireless access points.

In one implementation, the channel determiner may determine the alternate channels based on historical information about the likelihood of interference on the available channels. For example, if a channel is used in an area of the network and experiences co-channel interference, the same channel may not be assigned as an alternate channel in that area of the network. In one implementation, the channel determiner selects the primary and alternate channels based on a relationship between target communication performance on the primary channel and target communication on the alternate channel. For example, an administrator may prefer higher primary channel performance and be willing to sacrifice a lower alternate performance, or an administrator may prefer to have a more average alternate performance that may result in a lesser primary channel performance. The channel determiner may further select the channels based on the likelihood of a condition causing the wireless access point to use the alternate channel.

Proceeding to 502, a transmitter, such as the transmitter 402, transmits information about the associated primary radio channels to the wireless access points. The primary channel may be sent to the wireless access points so that the wireless access points may communicate using the primary channel. The transmitter may transmit the information via a wired network, and the wireless access points may use the primer radio channel for wirelessly transmitting information to client devices.

Moving to 603, the transmitter transmits information about the associated alternate radio channel to at least one of the wireless access points. For example, the processor may receive information that an access point experienced interference on its primary channel, and the processor may send information about the access point's alternate channel such that the access point may begin communicating on its alternate channel. In some implementations, the transmitter may send information about the alternate radio channel to the wireless access point in advance such that the wireless access point may store information about the alternate channel for future use.

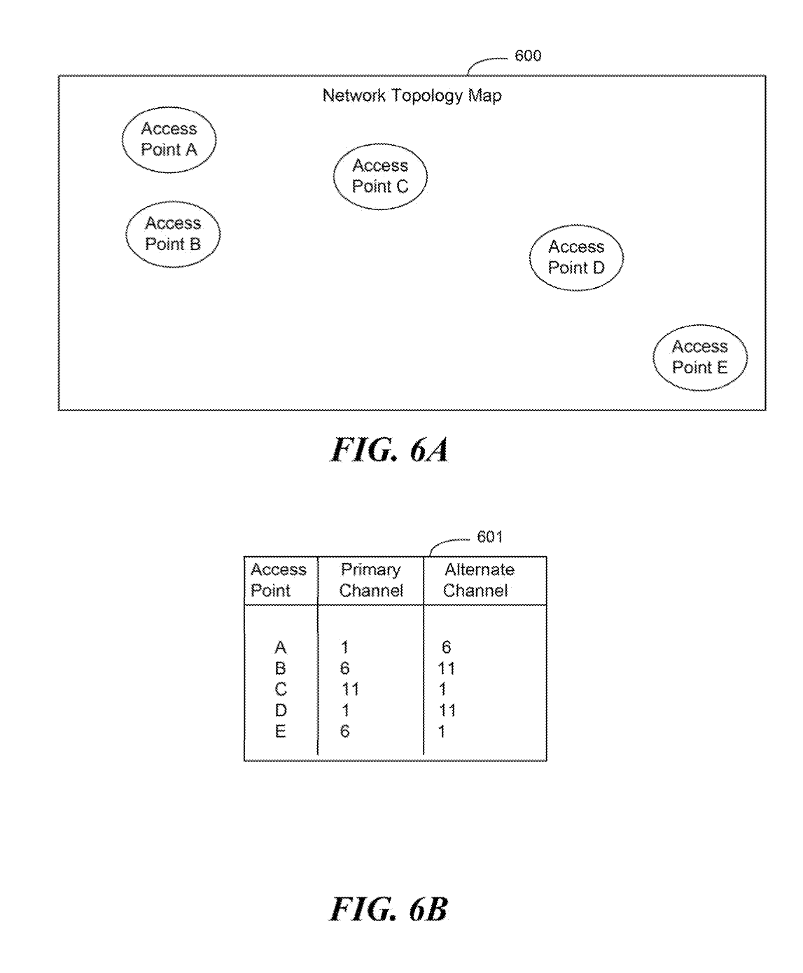

FIG. 6A is a diagram illustrating one example of a network topology map 600. The network topology map shows the location of access points A, B, C, D, and E. The location of the wireless access points may be used to determine a primary and alternate communication channel such that the communication channels are not the same as the communication channels of nearby wireless access points.

FIG. 6B is a diagram illustrating one example of a wireless access radio channel communication plan 601. For example, wireless access points A and B are near one another, and they have different primary communication channels to lessen the likelihood of co-channel interference. Wireless access point B has a different alternate channel than the primary channel and alternate channel of wireless access point A. Due to the limited number of channels, wireless access point A's alternate channel may result in co-channel interference with access point B. The channels may be selected, for example, based on the likelihood of a wireless access point switching to communicate on its alternate channel.

In one implementation, a test may be performed to determine the effectiveness of the primary and alternate channel assignments. For example, a processor may simulate interference of a first one of the wireless access points and monitor the wireless access point to determine whether the first wireless access point begins to communicate on the alternate channel. The processor may also monitor the performance on the alternate channel, such as whether client devices are able to communicate on the alternate channel and whether co-channel interference occurs. Results from the monitoring may be output, such as saved, displayed, or transmitted. A network administrator may receive a report if the test fails.

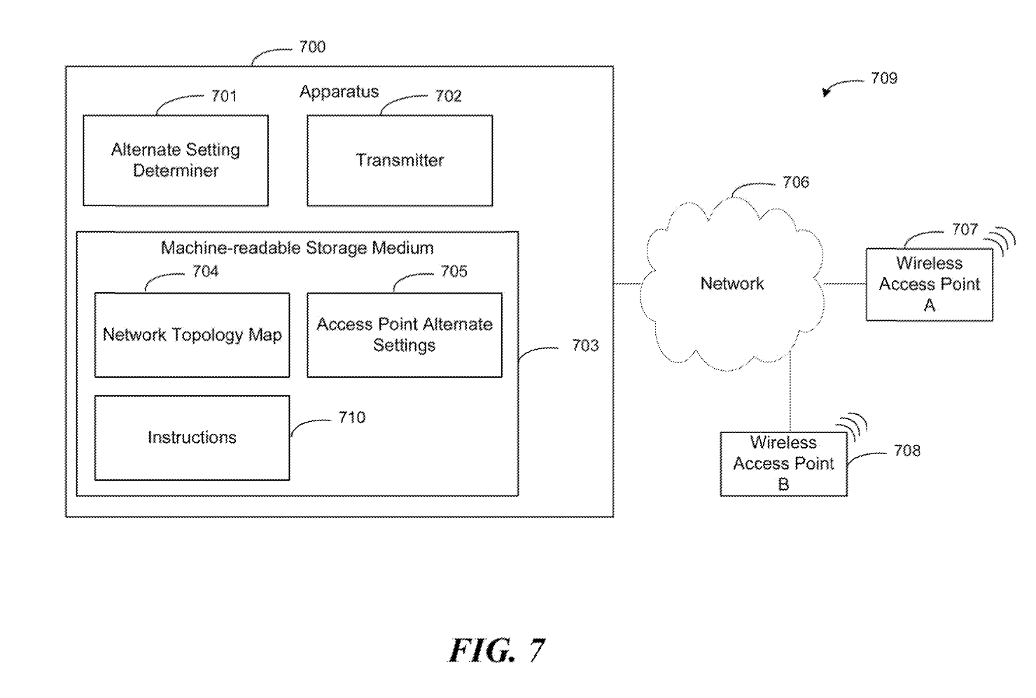

FIG. 7 is a block diagram illustrating one example of a computing system 709. The computing system 709 includes an apparatus 700, a network 706, a wireless access point A 707, and a wireless access point B 708. The computing system 709 may determine a response for a wireless access point failure using a network topology map of access points in the network. For example, other access points may transmit at a different power level or on a different channel to compensate for the unavailable wireless access point.

The wireless access points A 707 and B 708 may provide network access to client devices, For example, the wireless access points A 707 and B 708 may transmit information wirelessly via radio frequencies to client devices (not shown). In some implementations, the wireless access points A 707 and B 708 may be combined with other network hardware, such as a router.

The network 706 may be any suitable network, such as the Internet or a Local Area Network. The network 706 may communicate information from the apparatus 700 to the wireless access points A 707 and B 708. For example, the apparatus 700 may send information about communication channels or power levels to the wireless access points A 707 and B 708. The network 706 may be a wired network for transmitting information to the wireless access points A 707 and B 708, and the wireless access points A 707 and B 708 may wirelessly transmit data to client devices using radio frequencies.

The apparatus 700 may be any suitable apparatus for determining wireless access point settings. For example, the apparatus 700 may be a network controller, such as a wireless Local Area Network (LAN) controller, for centrally managing radio frequency power, channel, authentication, and security of wireless access points. The apparatus 700 may include an alternate setting determiner 701, a machine-readable storage medium 703, and a transmitter 702.

The alternate setting determiner 701 may be a processor, such as a central processing unit (CPU), a semiconductor-based microprocessor, or any other device suitable for retrieval and execution of instructions. In one embodiment, the alternate setting determiner 701 includes logic instead of or in addition to a processor. As an alternative or in addition to fetching, decoding, and executing instructions, the alternate setting determiner 701 may include one or more integrated circuits (ICs) or other electronic circuits that comprise a plurality of electronic components for performing the functionality described below. In one implementation, the alternate setting determiner 701 includes multiple processors. For example, one processor may perform some functionality and another processor may perform other functionality.

The machine-readable storage medium 703 may be any suitable machine readable medium, such as an electronic, magnetic, optical, or other physical storage device that stores executable instructions or other data (e.g., a hard disk drive, random access memory, flash memory, etc.). The machine-readable storage medium 703 may be, for example, a computer readable non-transitory medium. The machine-readable storage medium 703 may include network topology map 704 and access point alternate settings 705. The machine-readable storage medium 703 may include instructions 710 executable by the alternate setting determiner 701.

A processor may create and store the network topology map 704. The network topology map 704 may be a nearest neighbor map of wireless access points in the network indicating the proximity of access points to one another. The alternate setting determiner 701 may create and store the access point alternate settings 705. The access point alternate settings 705 may include for each access point or a subset of the access points, a response by other access points to respond to the failure of the wireless access point. The other wireless access points may respond such that client devices previously connecting to the failed wireless access point are still able to receive network coverage by connecting to one of the other wireless access points. For example, other wireless access points may transmit using a different channel with a greater range or may transmit with greater power.

The transmitter 702 may be a hardware component for transmitting information to the wireless access points A 707 and B 708 via the network 706. The apparatus 700 may receive information that a wireless access point has failed, and the transmitter 702 may notify the other wireless access points affected by the response information about how they should respond based on the access point alternate settings 705.

In some cases, the computing system 709 may be combined with the computing system 109 from FIG. 1 and the computing system 409 from FIG. 4. For example, a network controller may provide alternate plans for multiple issues that may arise with wireless access points.

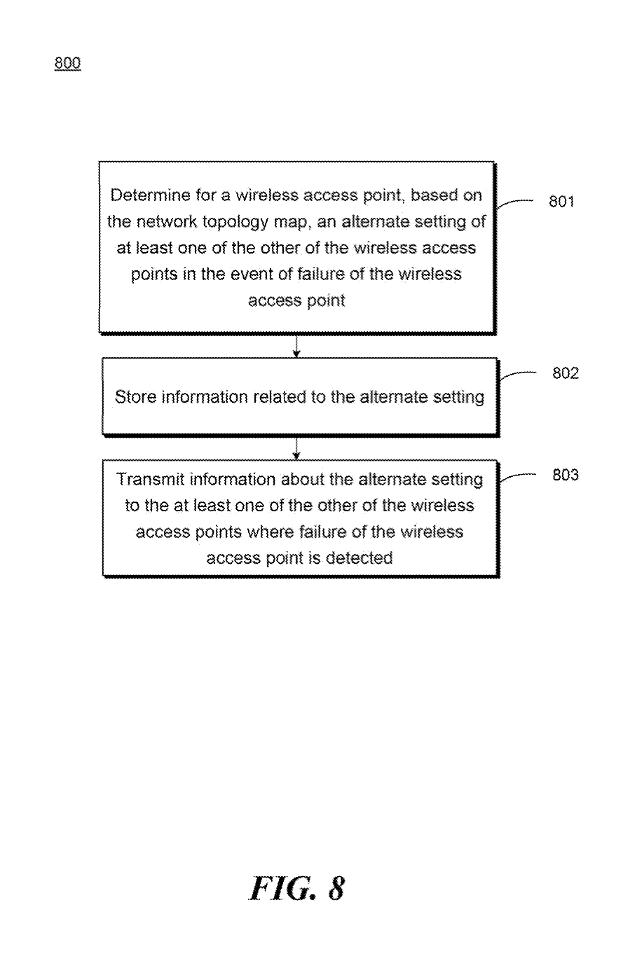

FIG. 8 is a flow chart 800 illustrating one example of a method to create an access point coverage alternate plan. A network controller may predetermine a plan to react to failure of wireless access points in a wireless network. The network controller may determine a response of other access points to mitigate the coverage hole created by the failure of the access point. Determining the plan in advance may allow for other wireless access points to respond more quickly, resulting in a shorter period of delay for client devices. The method may be implemented, for example, by the apparatus 700.

Beginning at 801, an alternate setting determiner, such as the alternate setting determiner 701, determines for a wireless access point, based on the network topology map, an alternate setting of at least one of the other of the wireless access points in the event of failure of the wireless access point. The network topology map may indicate which other wireless access point are near the failed wireless access point. The processor may determine that the nearby wireless access points may alter their communication settings to account for coverage lost due to the failed wireless access point. For example, if a first wireless access point fails, a nearby wireless access point may transmit at a higher power that will allow the range of the nearby wireless access point to reach client devices previously communicating with the failed wireless access point.

Continuing to 802, the alternate setting determiner stores information related to the alternate setting. An alternate setting determiner may store the predetermined plan such that it may be accessed and used when a wireless access point fails. Having the responses predetermined may make the responses occur more quickly than if the analysis occurred after the failure. The network connectivity may be restored more quickly to client devices previously connecting to the failed wireless access point.

Proceeding to 803, a transmitter, such as the transmitter 702, transmits information about the alternate setting to the at least one of the other of the wireless access points where failure of the wireless access point is detected. For example, if the stored plan indicates that a first and second wireless access point should transmit on different channels if a third wireless access point fails, the processor sends the updated channel information to the first and second wireless access points when the third wireless access point fails.

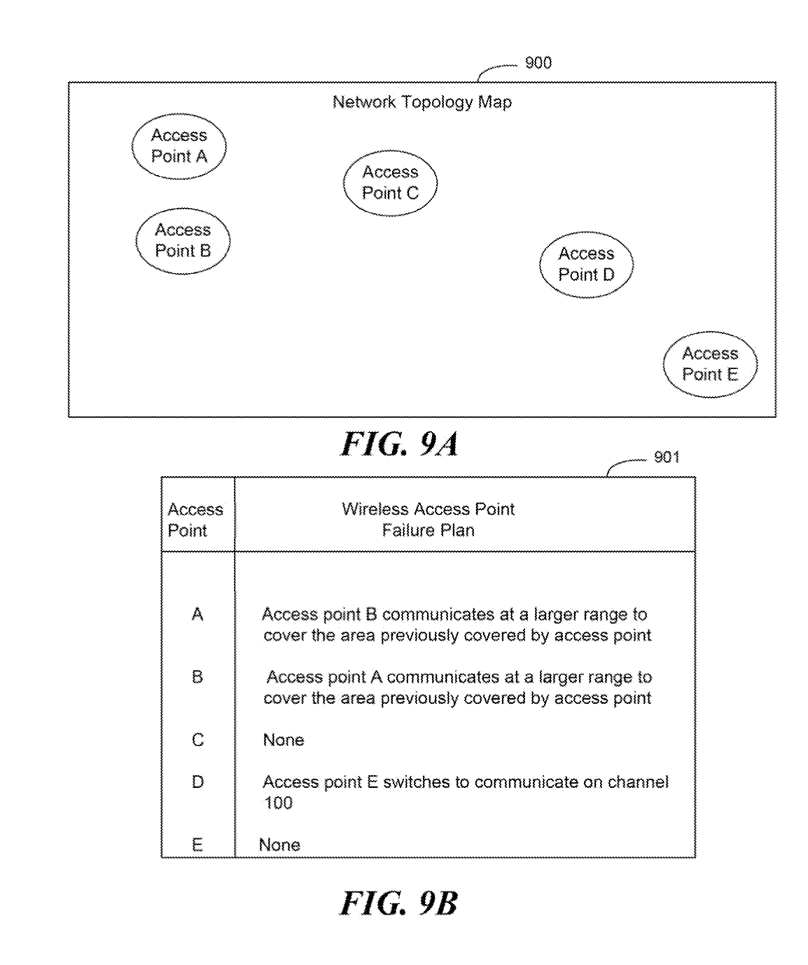

FIG. 9A is a diagram illustrating one example of a network topology map 900. The network topology map 900 indicates the relative position of wireless access points A, B, C, D, and E. For example, wireless access point B is closer to wireless access point A than wireless access point E is to A. The position information may be used to determine which wireless access points may be able to change transmission channel, power, or other setting to cover the area covered by another wireless access point.

FIG. 9B is a diagram illustrating one example of wireless access point failure plan 901. For each wireless access pint A, B, C, D, and E, a response of the other wireless access points is indicated. For example, if wireless access point A fails, a processor instructs wireless access point B to communicate with greater power at a larger range to cover the area previously covered by wireless access point A. In some cases, the creation of a wireless access point failure plan may identify wireless access points where other access points are unable to take over the coverage area. For example, for wireless access point E, the wireless access point may be too far from other wireless access points for another wireless access point to allow connectivity for the client devices previously connected to wireless access point E. The information about the plan may be output. For example, an administrator may choose to add hardware or make another network adjustment to create an adequate backup plan.

In one implementation, the processor performs a test by simulating failure of one of the wireless access points. For example, one of the access points may be turned off. The test may be beneficial because it may be performed at a time of lighter traffic and big events where connectivity is needed may be avoided. The processor may monitor the response of other wireless access points to determine whether the determined response was implemented, The processor may output information about the monitoring, such as storing, displaying, or transmitting it. For example, an administrator may receive a report about whether some client devices lost connectivity during the test.

Automated mitigation plans for wireless network issues may allow better network performance. For example, the stored plans indicating updated wireless access point settings may be implemented more quickly than a response determined after an issue arises. Automated plans may address issues such as alternate radio frequency channels and responses to wireless access point failure.

1. A method, comprising:
determining, by a processor, an alternate radio channel setting not designated for radar avoidance to associate with a wireless access point as an alternate to a primary radio channel associated with the wireless access point; and
transmitting information about the associated alternate radio channel to the wireless access points.

2. The method of claim 1, further comprising updating the associated alternate radio channel of the wireless access point based on use of an alternate channel by another wireless access point.

3. The method of claim 1, further comprising;
identifying that the wireless access point detected radar on the primary radio channel associated with the wireless access point; and
updating an associated primary radio channel of another wireless access point having an associated primary radio channel the same as the primary radio channel associated with the wireless access point.

4. The method of claim 1, further comprising:
determining that the wireless access point detected radar on the primary radio channel associated with the wireless access point; and
updating an associated primary radio channel of another wireless access point within a particular proximity of the wireless access point having an associated primary radio channel the same as the primary radio channel associated with the wireless access point.

5. The method of claim 1, further comprising:
simulating a condition to disrupt the communication on the associated primary radio channel of the wireless access point;
monitoring the communication of the wireless access point; and
outputting information related to the monitoring.

6. The method of claim 1, further comprising:
determining the primary radio channel designated for radar avoidance to associate with the wireless access point; and
transmitting information about the associate primary radio channel to the wireless access point.

7. An apparatus, comprising;
a storage to store a network topology map of wireless access points n a network; and
a determiner to:
determine for a wireless access point, based on the network topology map, an alternate setting of at least one of the other of the wireless access points in the event of failure of the wireless access point; and
store information related to the alternate setting; and
a transmitter to transmit information about the alternate setting to the at least one of the other of the wireless access points where failure of the wireless access point is detected.

8. The apparatus of claim 7, wherein the alternate setting comprises at least one alternate power level and an alternate radio channel.

9. The apparatus of claim 7, wherein the determiner is further to identify that the alternate setting fails to replace the network coverage of the wireless access point.

10. The apparatus of claim 7, further comprising a tester to:
simulate failure of the wireless access point;
monitor network coverage provided by at least one of the other of the wireless access points; and
output information about the monitoring.

11. A machine-readable non transitory storage medium including instructions executable by a processor to:
determine a primary radio channel and an alternate radio channel setting for a wireless access point based on a network topology map of wireless access points in a network;
transmit information about the associated primary radio channel to the wireless access point; and
transmit information about the associated alternate radio channel to the wireless access point.

12. The machine-readable non-transitory storage medium of claim 11, wherein transmitting information about the associated alternate radio channel comprises transmitting information about the associated alternate radio channel where interference is detected on the primary channel associated with the wireless access point.

13. The machine-readable non-transitory storage medium of claim 11, wherein determining the primary and alternate channel is based on a relationship between target communication performance on the primary channel and target communication performance on the alternate channel.

14. The machine-readable non-transitory storage medium of claim 11, wherein determining the alternate channel is based on historical information about the likelihood of interference on the group of available alternate channels.

15. The machine-readable non-transitory storage medium of claim 11, further comprising instructions to:
simulate interference of the wireless access point; and
monitor the communication of the wireless access point; and
output information related to the monitoring.
